(19) United States
(12) Patent Application Publication
(10) Pub. No.: US 2016/0325436 A1
(43) Pub. Date: Nov. 10, 2016

(54) ROBOT ARM JOINT, PARTICULARLY FOR HAPTIC AND/OR COBOTIC USES

(71) Applicant: COMMISSARIAT A L'ENERGIE ATOMIQUE ET AUX ENERGIES ALTERNATIVES, Paris (FR)

(72) Inventor: Alain RIWAN, CHEVILLY-LARUE (FR)

(73) Assignee: COMMISSARIAT A L`ENERGIE ATOMIQUE ET AUX ENERGIES ALTERNATIVES, PARIS (FR)

(21) Appl. No.: 15/108,946

(22) PCT Filed: Feb. 20, 2015
(86) PCT No.: PCT/EP2015/053579

§ 371 Date: Jun. 29, 2016

(30) Foreign Application Priority Data
Feb. 21, 2014 (FR) 14 51425

(51) Int. Cl. B25J 13/02; B25J 19/00

(52) U.S. Cl. CPC B25J 13/025; B25J 19/0004; Y10S 901/28; Y10S 901/23

(57) ABSTRACT

A motorized robot arm joint comprising a first segment (1), a second segment (2) moveably mounted on the first segment and driven by an actuator (8) connected to a control unit (20) and rigidly connected to a mounting (5) that has a first friction element (10) and is mounted on the first segment such that it moves when subjected to a driving force greater than a predetermined threshold and presses the first friction element against a second friction element (12) that is rigidly connected to the second segment. One of the friction elements is wedge-shaped and has a bisecting plane that is substantially parallel to a plane of movement of the second segment such that it can be engaged between two jaws (13.1, 13.2) of the other of the friction elements, the jaws having surfaces arranged so as to make point-by-point contact with the wedge shape.

The present invention relates to a joint for a robot arm, particularly designed for haptic and/or cobotic uses. Haptics is a field of robotics in which robots are used as a force feedback interface to permit the simulation of interactions with virtual physical environments. Cobotics is a field of robotics in which robots assist the user by sharing a single tool or task with the user in order to guide the user, offset the weight of the tool, gear down the force, and suppress spurious or unwanted user movements.

Such a robot arm joint usually includes a first segment and a second segment that are articulated with one another by a link with a degree of freedom and that are linked by an actuator arranged to move the second segment in relation to the first segment. One zone of the second segment is handled directly by the user (haptic) or is provided with an element such as a tool handled by the user (cobotic). A robot arm usually has several joints of this type, the exact number of which depends on the number of parts of the arm that are moveable in relation to one another in order to perform all of the desired movements.

More specifically, the invention relates to applications in which the intention is not to increase the user's force, but simply to guide the user's movements or to oppose such movements if they are unwanted, thereby making the gesture safer.

In addition to the natural capacity to move the segment downstream or to exert an active force on same, the action must have two opposing characteristics.

In normal time, the actuation of the arm must be transparent for the user, i.e. the user must not be able to feel any resistance or spurious movements opposing the movement the user wishes to make, but if necessary it must enable the application of significant forces intended to oppose the movement of the arm and to prevent the user from making an unwanted movement. This capacity to apply significant reaction forces is for example used to simulate an impact or contact with a virtual surface (if the arm is used with virtual-reality software) or to determine the boundaries of a working area that the tool attached to the end of the arm must stay inside. The actuator must therefore be quick and powerful. In haptics and cobotics, these two behaviors can be described using two magnitudes characterizing the performance of an actuator:
The extent of the mechanical impedance range that can be provided by the actuator (mechanical impedance being the resistance with which the actuator opposes the movement of the arm moved by an external force), the extent being ideally as great as possible,
The transition time between the minimum mechanical impedance (the robot offers the minimum resistance to the movement made by the user, the minimum impedance ideally being zero) and the maximum mechanical impedance (the robot opposes the movement made by the user, the maximum impedance ideally being infinite), this transition time ideally being as short as possible.

The use of pneumatic cylinders, hydraulic cylinders and electric motors as actuators is known, although none of these solutions fully satisfies the conditions set out above. In particular, with reference to electric motors, the most powerful electric motors are also those with the greatest inertia and the greatest friction, thereby resulting in prohibitive transition times for the intended application. This observation can be extrapolated to other types of actuator.

To overcome this drawback, it is known to combine the actuator with an elastic coupling, a magnetic coupling, a magnetorheological-fluid coupling or a mechanical variator to increase the mechanical impedance range that can be supplied by the actuator and to reduce the transition time between the lowest and highest mechanical impedance. The performance of such solutions is somewhat satisfactory, and in some cases they require an advanced degree of complexity that is also costly.

Document WO-A-201142151 discloses a motorized robotic-armed joint that improves the safety of haptic and co-Baltic applications without compromising ergonomics or performance. This motorized joint has a first segment, a second segment mounted moveably on the first segment, an actuator designed to reversibly transmit a movement to the second segment in relation to the first segment and blocking means that can be inserted between the first segment and the second segment and that can be controlled to make the transmission of movement temporarily non-reversible. The actuator is rigidly connected to a mounting carrying a first friction element and that is mounted on the first segment such that it can be moved, when subjected to a driving force greater than a predetermined threshold, such as to press the first friction element against a second friction element that is rigidly connected to the second segment, thereby forming the blocking means. The means for blocking rotation of the second segment act in parallel with the actuator to create a reaction force opposing the undesired movement. The actuator is therefore used to move the second segment in relation to the first segment or to a limit the movement of same. In this second case, if the external forces exerted on the second segment are greater than a predetermined force, then the blocking means combine with the actuator to provide the missing resistive force. The friction elements form relatively efficient blocking means, but are difficult to adjust.

One objective of the invention is to provide such a joint in which the blocking means are effective and simple to use.

For this purpose, the invention describes a motorized robot arm joint comprising a first segment, a second segment moveably mounted on the first segment and driven by an actuator connected to a control unit and rigidly connected to a mounting that has a first friction element and is mounted on the first segment such that it moves when subjected to a driving force greater than a predetermined threshold and presses the first friction element against a second friction element that is rigidly connected to the second segment. One of the friction elements is wedge-shaped and has a bisecting plane that is substantially parallel to a plane of movement of the second segment such that it can be engaged between two jaws of the other of the friction elements, the jaws having surfaces arranged so as to make point-by-point contact with the wedge shape.

Thus, the inclusion of surfaces making point-by-point contact makes the blocking means more tolerant to manufacturing defects, and in particular relative positioning faults.

Advantageously, the surfaces of the jaws are spherical.

The surfaces are then relatively simple to form, for example by machining.

Also advantageously, the jaws are assembled with a clearance in a direction substantially normal to the bisecting plane.

This makes the blocking means even more tolerant to manufacturing defects, and in particular relative positioning faults.

According to a preferred embodiment, the second segment is mounted on the first segment to pivot about an axis perpendicular to the first segment and is rigidly connected to a second wheel coaxial to the axis of rotation such that the second wheel forms the drive element of the second segment, and the mounting is preferably arranged such as to pivot about an axis parallel to said axis.

As long as the tangential force generated by the torque of the joint (resultant of the drive torque and the torque resisting movement of the second segment) is less than the predetermined threshold, the second segment rotates freely (the mounting is then in a position referred to as the inactive position). Conversely, once said tangential force is greater than the threshold, the mounting of the motor is driven in rotation until the mounting brings the friction elements into contact (the mounting is then in a position referred to as the active position). The blocking is then provided by exerting a force directly on the second segment. The residual movement of the segment between the position of same at the moment of triggering and the position of same where blocking takes effect can be adjusted by adjusting the space between the friction elements when the mounting is in the inactive position. The smaller this space, the greater the precision.

Preferably, the predetermined threshold is set by calibrating at least one spring arranged to exert a force on the mounting that opposes a movement of same to bring the friction element into contact.

This method for determining the threshold, which is less than the maximum torque provided by the motor, is extremely simple. Furthermore, the threshold can be simply adjusted by adjusting the pre-stressing of the spring.

Other features and advantages of the invention are set out in the following description of specific, nonlimiting embodiments of the invention.

Reference shall be made to the attached drawings, in which:

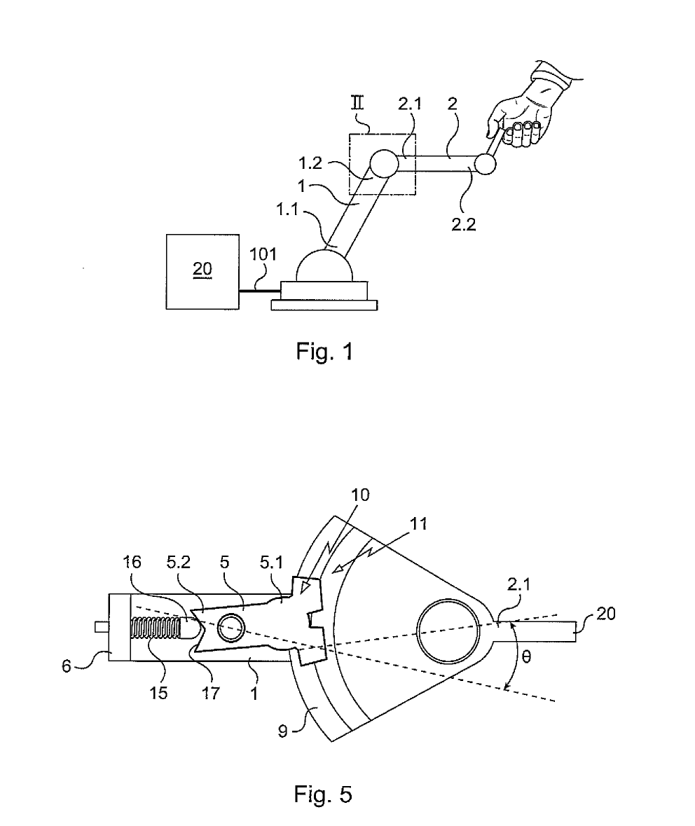

FIG. 1 is a schematic view of an arm according to the second embodiment of the invention,

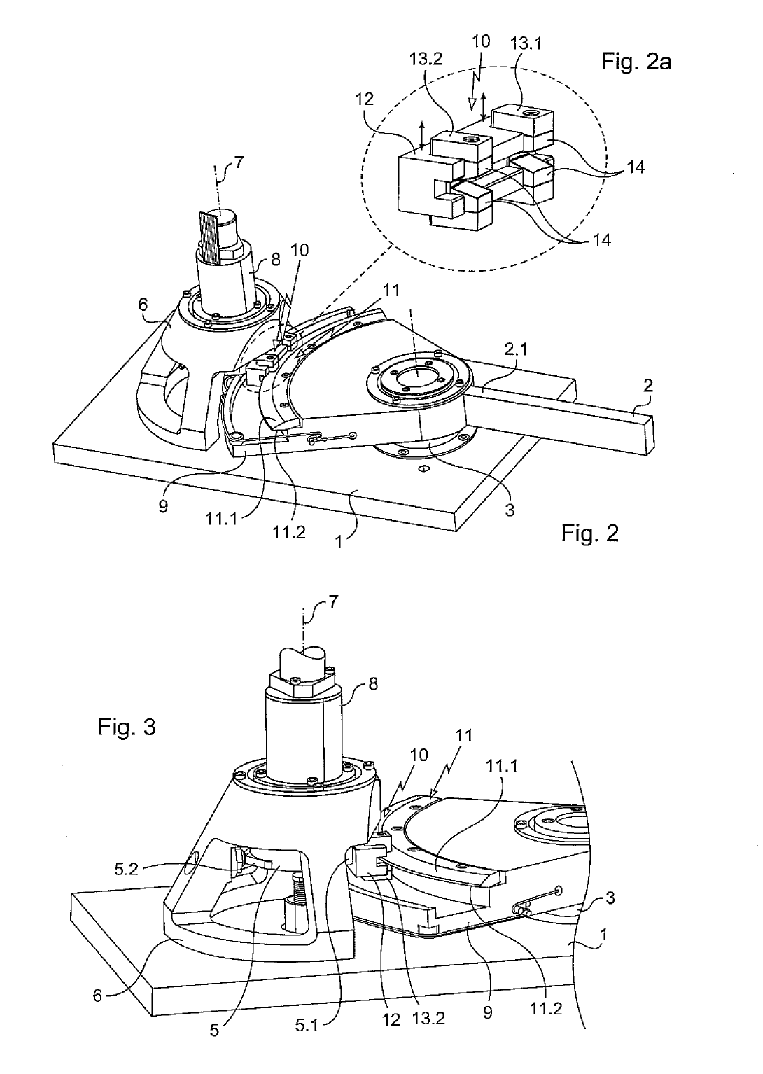

FIG. 2 is a magnified perspective view of zone II in FIG. 1 and FIG. 2a is a detailed view of FIG. 2,

FIG. 3 is a view similar to FIG. 2 from another angle,

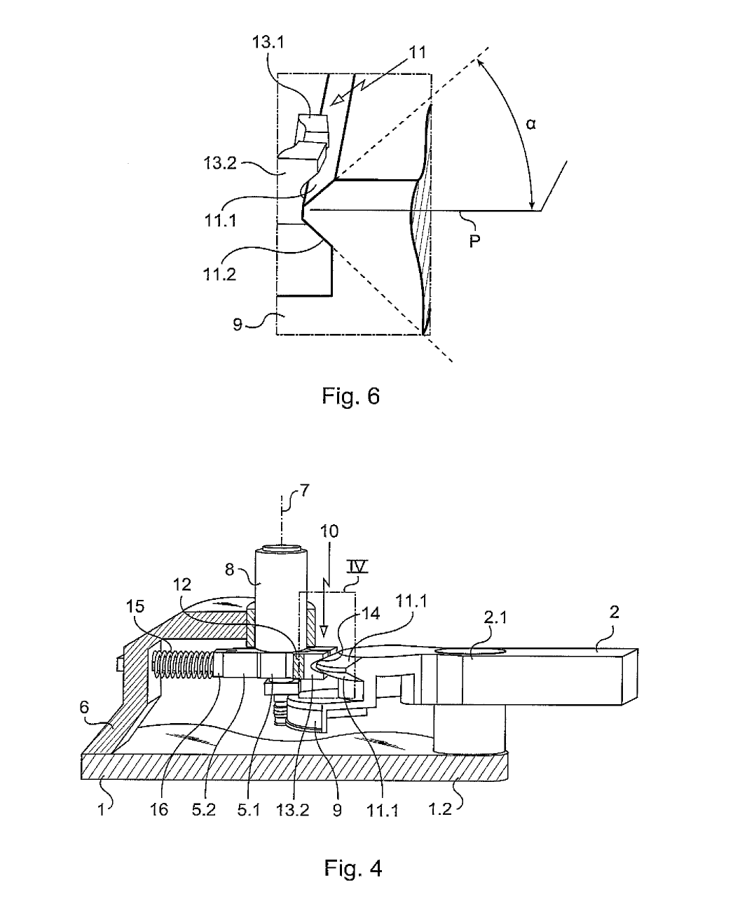

FIG. 4 is a partial perspective cut-away view of the joint according to the invention, with no force being exerted on the second segment,

FIG. 5 is a top view of this joint, with a force being exerted on the second segment,

FIG. 6 is a magnified view of zone VI in FIG. 4,

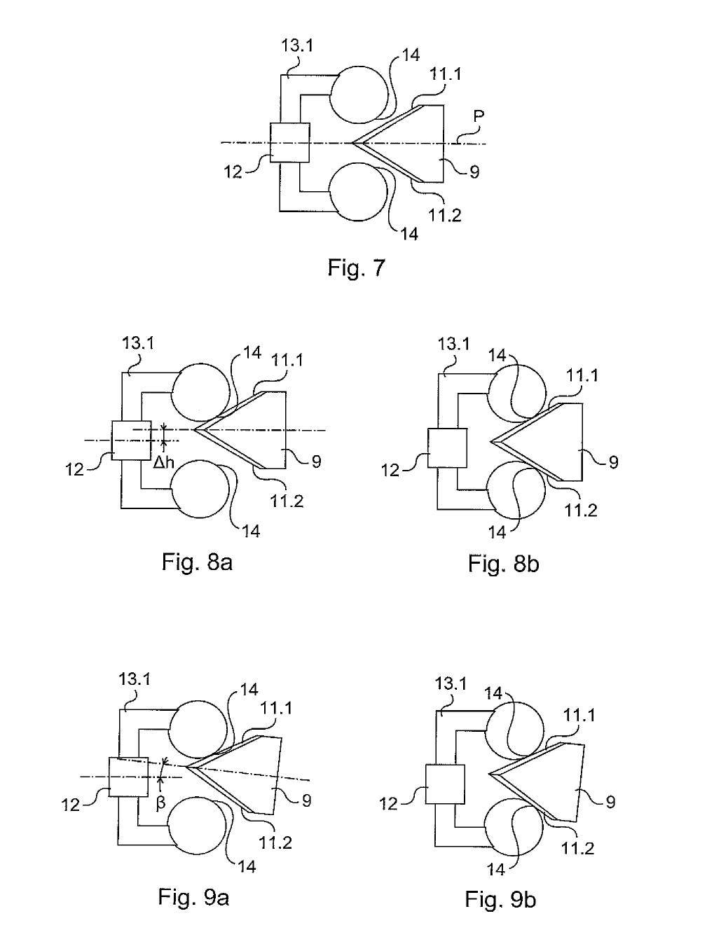

FIG. 7 is a schematic view of the friction elements in the joint according to the invention,

FIGS. 8a, 8b are views similar to FIG. 7 showing the engagement of the friction elements in the event of vertical offsetting,

FIGS. 9a, 9b are views similar to FIG. 7 showing the engagement of the friction elements in the event of angular offsetting.

The motorized joint according to the invention is described here in relation to a surgical application. The free extremity of the arm is fitted with a drill handled by a surgeon to remove the diseased parts of the body of a patient without touching the healthy parts.

With reference to the figures, the arm joint according to the invention has a first segment 1 and a second segment 2 that extend on either side of the joint to form the parts of the arm. The segments can therefore be formed as a single part with the arm parts, or be attached permanently or removably to same.

The first segment 1 has a first extremity 1.1 linked to a base 101 and a second extremity 1.2 rigidly attached to a shaft 3 on which a first extremity 2.1 of the second segment 2 is mounted pivotingly, said second segment having an opposing second extremity 2.2 fitted with a tool (not shown).

The joint includes a mounting 5 arranged on the first segment 1 to pivot about an axis 7 parallel to the axis of articulation of the second segment 2 with the first segment 1. The mounting 5 is in this case carried by a substantially frustoconical tubular frame 6, the large section of which is attached to the segment 1.

A motor 8 is assembled on the mounting 5 such that the output shaft of the same coincides with the axis 7. Balancing the assembly of mounting 5 and motor 8 is relatively simple on account of the coaxiality of same. Furthermore, the force exerted by the motor 8 on the mounting 5 does not depend on the orientation of the arm in relation to the gravitational field, in particular when the axis of rotation of the mounting 5 is not parallel to gravity.

The output shaft of the motor 8 engages via a cable with a wheel sector 9 that is rigidly connected to the extremity 2.1 of the second segment 2. Alternatively, the output shaft may carry a cog that meshes with teeth formed on the wheel sector 9.

The mounting 5 has an extremity 5.1 provided with a friction element, identified as a whole using reference sign 10, extending opposite a friction element, identified as a whole using reference sign 11, that is rigidly connected to the extremity 2.1. The friction elements 10, 11 form a member for blocking rotation of the segment 2 in relation to the segment 1.

The friction element 11 is more specifically attached to the wheel sector 9 and extends in an arc coaxially to the axis 3. The shape of the friction element 11 is an annular sector with a wedge-shaped profile delimited laterally by two frustoconical surfaces 11.1, 11.2 that are coaxial to the axis 3 and that come together to form a peripheral edge oriented radially outwards. The friction element 11 has a bisecting plane P that is substantially parallel to the plane to which the segment 2 moves in parallel, i.e. a plane perpendicular to the axis 3.

The friction element 10 includes a jaw holder 12 rigidly attached to the mounting 5 and provided with two pairs 13.1, 13.2 of jaws (for convenience, the pair 13.1 of jaws shall be referred to as jaw 13.1 and the pair 13.2 of jaws shall be referred to as jaw 13.2). The jaws 13.1, 13.2 are separated from one another in a plane perpendicular to the axis 7 such that each one extends on one side of the longitudinal direction of the mounting 5 (the longitudinal direction of the mounting 5 crosses the middle of the extremity 5.1 and the axis 7). The jaws 13.1, 13.2 are mounted on the jaw holder 12 to slide parallel to the axis 3. Each jaw 13.1, 13.2 includes contact surfaces 14 that each extend on one side of the bisecting plane P and that have a convex shape in two directions to make point-by-point contact with the surfaces 11.1, 11.2. The contact surfaces 14 may for example be spherical caps.

The mounting 5 has an inactive position of the blocking member and two active positions of the blocking member on either side of the inactive position.

The mounting 5 is in the inactive position when the longitudinal direction of the mounting 5 extends radially in relation to the wheel sector 9 and the friction element 11. In this position, there is a space between the contact surfaces 14 of the jaws 13.1, 13.2 of the friction element 10 and the surfaces 11.1, 11.2 of the friction element 11.

The mounting 5 is in the active position when the contact surfaces 14 of one of the jaws 13.1, 13.2 of the friction element 10 are in contact with the surfaces 11.1, 11.2 of the friction element 11. The mounting 5 (more specifically the plane containing the axis 7 and the point of contact of the contact surfaces 14 with the surfaces 11.1, 11.2) then forms an angle with the radial plane of the friction element 11 passing through the point of contact of the contact surfaces 14 (see FIG. 5) in which θ is the angle between the mounting 5 and the radial plane in question, μ is the coefficient of friction of the pair of materials of the contact surfaces 14 and the surfaces 11.1, 11.2, and α is the half angle at the top of the V formed by the surfaces 11.1 and 11.2, tan(θ)sin(α)<μ is an essential condition for blocking and tan(α)>ρ is an essential condition to prevent jamming that would oppose the unblocking of the segment 2.

The mounting 5 is returned to the inactive position by a return spring 15 working in compression to exert a force on the mounting 5 opposing a movement of same to activate the blocking member. The return spring extends radially in relation to the wheel sector 9 with one extremity bearing against the frame 6 and an opposite extremity pushing back a pin 16 seated in a V-shaped seat 17 formed in the extremity 5.2 of the mounting 5 opposite the extremity 5.1 of the mounting 5. The angle of the V makes it possible to adjust the artificial feel load generated by the spring 15 when it is opposing the movement of the mounting 5. It can be seen that it is easy to prestress the spring 15 to adjust the trigger threshold of the blocking mechanism. For example, a nut assembled coaxial to the pin 16 may be provided to shorten the length of the spring 15.

The motor 8 is naturally dimensioned to move the segment 2 in relation to the segment 1 and is linked to a control unit 20.

The control unit 20 is a computer arranged to run a program for controlling said motor. In the surgical application envisaged, the control program delimits a working zone delimited by a boundary envelope defined using medical imaging. The control unit 20 controls the motor 8 such that the arm follows the movements of the drill being handled by the surgeon within the limits of the boundary envelope and blocks the motor 8 to oppose movement of the drill outside the limits of the boundary envelope. During simulation of a contact, the motor 8 is instructed to resist (initial torque increase) before the blocking device is activated (activation resulting in a second torque increase). The envelope can be followed before the second torque increase.

Any force exerted by the motor on the second segment 2 creates a reaction force transmitted to the mounting 5 that tends to rotate and to bring one or other of the jaws 13.1, 13.2 against the surfaces 11.1, 11.2 (depending on the relative direction of rotation of the segments 1 and 2 and the direction of rotation of the motor 8). The lateral offsetting of the jaws 13.1, 13.2 in relation to the longitudinal direction of the mounting 5 also creates over-center conditions that strengthen the blocking.

The resisting force provided by the spring 15 opposing the rotation of the mounting 5 is a force threshold for activation of the blocking member. This force is set such that the friction elements 10, 11 come into contact with one another before the motor 8 outputs maximum force.

With reference more specifically to FIGS. 7 to 9b, the blocking member is relatively tolerant of relative positioning errors of the jaws 13 and of the friction element 11.

Thus, in FIGS. 8a, 8b, the friction element 11 is vertically offset by a distance Δh upwards in relation to the mounting 5. During activation of the blocking member, one of the jaws 13.1, 13.2, in this case jaw 13.1, moves towards the friction element 11 and only the upper contact surface 14 comes into contact with the surface 11.1. As said elements move closer together, the upper contact surface 14 rubs against the surface 11.1 and causes the jaw 13.1 to slide vertically until the lower contact surface 14 comes back into contact with the surface 11.2, causing the relative blocking of the segments.

In FIGS. 9a, 9b, the friction element 11 is offset angularly by an angle 13 in a radial plane in relation to the mounting 5. During activation of the blocking member, one of the jaws 13.1, 13.2, in this case jaw 13.1, moves towards the friction element 11 and only the upper contact surface 14 comes into contact with the surface 11.1. As said elements move closer together, the upper contact surface 14 rubs against the surface 11.1 and causes the jaw 13.1 to slide vertically until the lower contact surface 14 comes back into contact with the surface 11.2, causing the relative blocking of the segments.

Naturally, the invention is not limited to the embodiments described, but covers all variants falling within the scope of the invention, as defined by the claims.

In particular, the first segment may be formed by a section of the arm, a torso or a base of a robot.

The structure of the arm need not be exactly as described: the second segment may for example be moveable in translation in relation to the first segment. Conversely, the actuator may be a cylinder driving a rack meshed with a cog or a motor driving a wheel running on a track, which may be rectilinear or otherwise. Kinematic inversion is also possible.

The arm may include an actuator for each of the joints or for only one or more of same (torso, shoulder, elbow, wrist, etc.).

The shapes of the segments need not be as represented.

The axis of the motor need not coincide with the axis of rotation of the mounting.

The male friction element may be mounted on the mounting and the female friction element on the second segment.

The mounting may be designed to slide instead of to pivot.

Alternatively, one of the friction elements (in this case, for example, the friction element 11) may have contact surfaces that are superposed Vs in cross section (as in a sheave) or any other shape.

Alternatively, the jaws 13 may be mounted on the jaw holder 12 such that each one pivots about an axis perpendicular to the axis 7, instead of being designed to slide parallel to same. Alternatively, the jaws 13 may be mounted on the jaw holder 12 such that each one slides along an axis perpendicular to the axis 7, instead of being designed to slide parallel to same.

The return spring may extend tangentially to a trajectory of the mounting to oppose a movement of the mounting to bring the friction elements into contact.

The spring may also be a flexible blade spring pressing a V-shaped part.

The friction element could include just one pair of jaws if the blocking only needs to be applied in one direction of rotation.

The invention can be applied to any joint “i” between two segments that can be positioned within a jointed mechanism with a number “n” of joints numbered from 1 to n.

1. A motorized robot arm joint comprising a first segment (1), a second segment (2) moveably mounted on the first segment and driven by an actuator (8) connected to a control unit (20) and rigidly connected to a mounting (5) that has a first friction element (10) and is mounted on the first segment such that it moves when subjected to a driving force greater than a predetermined threshold and presses the first friction element against a second friction element (12) that is rigidly connected to the second segment, characterized in that one of the friction elements is wedge-shaped and has a bisecting plane that is substantially parallel to a plane of movement of the second segment such that it can be engaged between two jaws (13.1, 13.2) of the other of the friction elements, the jaws having surfaces arranged so as to make point-by-point contact with the wedge shape.

2. The joint as claimed in claim 1, characterized in that the surfaces of the jaws (13.1, 13.2) are spherical.

3. The joint as claimed in claim 1, characterized in that the jaws (13.1, 13.2) are assembled with a clearance in a direction substantially normal to the bisecting plane.

4. The joint as claimed in claim 1, characterized in that the actuator includes a motor (8) with an output shaft linked to a first wheel that is engaged with a drive element of the second segment.

5. The joint as claimed in claim 4, characterized in that the second segment (2) is assembled on the first segment (1) to pivot about an axis (3) perpendicular to the first segment and is rigidly connected to a second wheel (9) that is coaxial to the axis of rotation such that the second wheel forms the drive element of the second segment.

6. The joint as claimed in claim 5, characterized in that the mounting (5) is designed to pivot, and the mounting and the motor (8) are substantially coaxial.

7. The joint as claimed in claim 1, characterized in that the predetermined threshold is set by calibrating at least one spring (15) arranged to exert a force on the mounting (5) that opposes a movement of same to bring the friction element into contact.

8. The joint as claimed in claim 7, characterized in that the mounting (5) has a seat with a substantially V-shaped bottom (17) designed to receive a pin (16) arranged to slide in a plane of movement of the mounting, the spring (15) extending between the segment and the pin to press the latter against the bottom of the seat.

9. The joint as claimed in claim 7, characterized in that the spring (15) extends tangentially to a trajectory of the mounting to oppose a movement of the mounting to bring the friction elements into contact.
